(19) United States
(12) Patent Application Publication
(10) Pub. No.: US 2025/0182609 A1
(43) Pub. Date: Jun. 5, 2025

(54) Adaptive Monitoring System and Method

(71) Applicant: Essence Security International (E.S.I.) Ltd., Herzlia Pituach (IL)

(72) Inventors: Ohad AMIR, Herzlia (IL); Ran ROSENBLUM, Petach Tikva (IL); Gregory MORAV, RaAnana (IL); Nissim TUGENDHAFT, Netanya (IL); Boaz MENIS, Kibbutz NaAn (IL); Jonathan Mark SCHNAPP, Tel Aviv (IL)

(21) Appl. No.: 18/725,658

(22) PCT Filed: Dec. 29, 2022
(86) PCT No.: PCT/IL2022/051411

§ 371 Date: Jun. 28, 2024

(30) Foreign Application Priority Data
Dec. 30, 2021 (IL) 289519

(51) Int. Cl. G08B 29/18; G08B 13/19; G08B 29/26

(52) U.S. Cl. CPC G08B 29/188; G08B 13/19; G08B 29/26

(57) ABSTRACT

A monitoring system is disclosed comprises a passive infrared, PIR, detector configured for detecting motion in an environment and an active reflected wave detector arranged to measure wave reflections from a region of interest in the environment. The active reflected wave detector is operable responsive to detection of motion by the PIR detector. The system is configured to adjust at least one parameter of the PIR detector responsive to the output of the active reflected wave detector meeting one or more criteria. A method, controller and computer program product are also disclosed.

### RELATED APPLICATION/S

This application claims the benefit of priority of Israel Patent Application No. 289519 filed on Dec. 30, 2021, the contents of which are incorporated herein by reference in their entirety.

### FIELD

The present disclosure relates to monitoring systems, particularly those that comprise a PIR motion detector and an active reflected wave detector.

### BACKGROUND

Motion sensors are designed to monitor a defined area, which may be outdoors (e.g., an entrance to a building, a yard, and the like), and/or indoors (e.g., within a room, in proximity of a door or window, and the like). Motion sensors may be used for security purposes, to detect intruders based on motion in areas in which no motion is expected, for example, an entrance to a home at night.

Some monitoring systems employ a motion sensor in the form of a passive infrared (PIR) detector to sense the motion (and by implication presence) of a heat-radiating body (i.e., such a heat-radiating body could be indicative of the presence of an unauthorized person) in its field of view. Depending on the particular system, the system may then issue an alarm such as an audible alarm sound, transmit a notification alerting another device of a detected event, and/or take another action, responsive to the detection of the moving body.

Other sensors can be used to monitor the defined area, such as active reflected wave detectors. One example of an active reflected wave detector is a radar ranging reflected wave detector but other types of active reflected wave detectors could be used.

### SUMMARY

According to a first aspect of the present disclosure is a monitoring system comprising:
a passive infrared, PIR, detector configured for detecting motion in an environment;
an active reflected wave detector arranged to measure wave reflections from a region of interest in the environment; wherein
the active reflected wave detector is operable responsive to detection of motion by the PIR detector; and
the system is configured to adjust at least one parameter of the PIR detector responsive to the output of the active reflected wave detector meeting one or more criteria.

By using the PIR detector (also referred to herein as a PIR motion detector) to trigger operation of the active reflected wave detector, the active reflected wave detector can operate in a lower power state (e.g. off or asleep) and only be turned on and/or measure wave reflections from the environment when the PIR detector detects motion in the environment. This is advantageous because typically the active reflected wave detector consumes more power in an activated state (i.e. when turned on and operational) than the PIR detector in an activated state.

The active reflected wave detector may be able to determine some properties of a detected entity such as location, distance and motion (direction and/or speed) of the entity and may be able to determine properties of the detected entity that the PIR detector can't or determine the properties of the detected entity more accurately than the PIR detector. As such, the active reflected wave detector may be operable responsive to detection of motion by the PIR detector to confirm the detection of motion by the PIR detector and/or to obtain additional, confirmatory or alternate information about the entity that gave rise to the motion detected by the PIR detector. However, by adapting at least one parameter of the PIR detector responsive to the output of the active reflected wave detector meeting one or more criteria, the active reflected wave detector may be used to automatically adjust at least one parameter of the PIR, which may be done in use and on the fly, to thereby improve the operation of the PIR detector. In addition, by adapting at least one parameter of the PIR detector responsive to the output of the active reflected wave detector meeting one or more criteria, the ability of the PIR motion detector to trigger the active reflected wave detector, e.g. with respect to the region of interest or to an entity type of interest, such as a human rather than a pet, may be improved.

The active reflected wave detector may be or comprise at least one of: a radar, a sonar, a LIDAR, and/or the like. The active reflected wave detector may be a ranging active reflected wave detector, e.g. operable to determine a distance and/or bearing to a detected entity, and may therefore provide measurements corresponding to coordinates in multiple dimensional space, e.g. two or more, advantageously three dimensional space.

The active reflected wave detector may be triggered responsive to detection of motion by the PIR detector, e.g. switchable from a first state to at least a second state. The first state may comprise one or more or each of: a deactivated state, an off state, a lower powered state and/or a non-sensing state. The second state may comprise one or more or each of: the activated state, an on state, a higher powered state than the first state and/or a sensing state.

The at least one parameter of the PIR detector may define a controllable behavioural characteristic of the PIR detector that determines how the PIR detector responds to a moving infrared-light emitting object. The at least one parameter of the PIR detector may be a parameter that affects the operation of the PIR detector in determining motion. The at least one parameter of the PIR detector may be a parameter used in determining that motion has been detected, or may at least be a parameter upon which the determining that motion has been detected depends. The at least one parameter of the PIR detector may comprise a parameter used to determine from the output of a pyroelectric sensor module of the PIR detector that motion has been detected.

The at least one parameter of the PIR detector may be at least one parameter that determines, sets or defines an effective range (also referred to herein as sensing range) of the PIR detector. The at least one parameter of the PIR detector may be at least one parameter that determines, sets or defines a sensing range of the PIR detector, the sensing range being a maximum distance the PIR detector can reliably detect motion, e.g. to at least a predetermined or set level. The predetermined or set level may be a level indicative of typical motion of a human, for example within a certain range of weights, sizes and/or speeds typically associated with unassisted human motion. The predetermined or set level may be comprised in or indicative of a performance specification, which may be specified or specifiable, for example, by at least one of: a supplier, a manufacturer and/or a user. Therefore, beyond the sensing range, detection to the predetermined or set level may be unlikely and/or unguaranteed.

The at least one parameter may be or comprise one or more detection thresholds, such as one or more thresholds that are used to determine whether a signal of the PIR detector, such as a signal output from the pyroelectric sensor module of the PIR detector, is indicative of motion. The one or more detection thresholds may comprise at least one threshold indicative of, or a digital equivalent of, a threshold electrical output parameter, such as at least one of a voltage parameter or a current parameter, which may be supplied to a comparison stage of the PIR detector.

The at least one parameter may comprise at least one parameter that defines one or more frequency bands of radiation that the PIR detector detects or is sensitive to, e.g. to meet the requirements of the performance specification. The at least one parameter may comprise a lower limit of at least one of the one or more frequency bands and/or an upper limit of at least one of the one or more frequency bands. The at least one parameter may comprise a plurality of thresholds associated with different frequency bands, and the adjusting of the at least one parameter may comprise varying selected thresholds of the plurality of thresholds, e.g. thresholds associated with selected frequency bands, such as a low frequency band or a high frequency band. The low frequency band may be a frequency band comprised in a lower half of an operable frequency range of the PIR detector, e.g. below 2 Hz, below 2.5 Hz, or below 3 Hz, but may be different depending on the particular PIR detector used. The high frequency band may be a frequency band comprised in an upper half of an operable frequency range of the PIR detector, e.g. above 2 Hz, above 2.5 Hz, or above 3 Hz, but may be different depending on the particular PIR detector used. The low and high frequency bands may be relative to each other, e.g. the low frequency band may be a non-overlapping frequency band that consists of frequencies lower than a lowest frequency of the high frequency band. The at least one parameter may comprise at least one parameter that sets frequencies passed by a filter such as a band pass filter or high pass filter, such as an upper or lower limit of the frequencies passed by the filter. The at least one parameter of the PIR motion detector may comprise a cut-off frequency parameter defining a cut-off frequency, such as an upper or lower cut-off frequency, of a filter applied by a gain stage of the PIR motion detector.

The at least one parameter may comprise a gain of the PIR detector, which may define a level of gain applied by a gain stage of the PIR detector. The at least one parameter may comprise sensitivity of the PIR detector.

The at least one parameter may comprise at least one parameter of a transfer function or gain vs frequency profile of the PIR detector. The adjusting of the at least one parameter may comprise modifying the gain uniformly across all frequencies or by changing the frequency response profile to have higher or lower gain at some frequencies compared with other frequencies. The adjusting of the at least one parameter may comprise raising or lowering or otherwise adjusting at least part or all of the gain vs frequency profile, which may comprise adjusting a lower frequency part of the gain profile corresponding to the low frequency band or an upper frequency part of the gain profile corresponding to the high frequency band. Thus, or otherwise, the gain vs frequency profile may be adjusted by increasing or decreasing the gain for signals of some frequencies in comparison with other frequencies. By only adjusting the at least one parameter that relates to only selected frequencies or frequency bands, the variation in the PIR detector parameters may be applied only to selected parts of the frequency profile that relate to specific detections, such as detection of pets or other animals rather than humans or vice versa.

The system may be configured to adjust the one or more parameter of the PIR detector only within a set or predetermined band or above, below and/or between one or more set or predetermined limits, e.g. upper and/or lower limits. The term ‘band’ here is used to mean range in the sense of there being upper and lower limits of a parameter (any parameter), which is distinct from any uses of ‘range’ herein that relate to either a maximum distance of detectability or a determined distance to an object. The adjusting of the at least one parameter may be restrained to be one or more of below an upper limit, above a lower limit and/or between the upper and lower limits. These features may avoid a situation where the sensing range of the PIR detector is undesirably reduced to a very low level in which detection is unlikely to take place unless the entity is undesirably close to the PIR detector and/or when the PIR detector is made too sensitive and prone to false readings (i.e. false positives/false detections).

The system may configured to temporarily or transiently adjust at least one parameter of the PIR detector. The system may be configured to automatically at least partially reverse or reset the at least one parameter of the PIR detector with time, e.g. with time elapsed since a most recent instance of the output of the active reflected wave detector meeting the one or more criteria. The reverse or reset of the at least one parameter of the PIR detector with time may be towards and/or to a previous or pre-set value. The reverse or reset of the at least one parameter of the PIR detector with time may be gradual over time since a most recent instance of the output of the active reflected wave detector meeting one or more criteria. The reverse or reset of the at least one parameter of the PIR detector with time may comprise a switch or step change upon commencement of a period of the day (e.g. night-time), at a set time or after a threshold period since a most recent instance of the output of the active reflected wave detector meeting one or more criteria. The above features avoid temporary events, for example a large animal running through the sensing region, leading to a prolonged adjustment of the at least one parameter of the PIR detector that may be less suited to the long-term or typical situation.

The one or more criteria may comprise an analysis of an output of the active reflected wave detector or output derived therefrom determining that the detected motion by the PIR detector was caused by a non-human entity, such as a pet or other non-human animal. The determination that the detected motion was due to a non-human entity may, for example, be an assumption based on the output of the active reflected wave detector or output derived therefrom being, immediately after the detected motion, or as close to immediately after the detected motion as practical, indicative of there being motion or presence a non-human entity and that also there is no presence of a human entity. The output derived therefrom may comprise the output of a classifier that classifies the output of the active reflected wave detector. The classifier may determine if the output of the active reflected wave detector is indicative of presence or motion of a human. The classifier may determine if the output of the active reflected wave detector is indicative of presence or motion of the non-human entity, such as a pet or other animal. The classifier may determine if the output of the active reflected wave detector is indicative of no presence or motion, e.g. no presence or motion of a human and/or a non-human entity. The classifier may determine a direction and/or rate of motion, e.g. of the human and/or non-human entity.

The adjusting of the one or more parameters of the PIR detector may comprise adjusting one or more parameters of the PIR detector that determine the ability or sensitivity of the PIR detector to detect and/or identify non-human entities such as pets or other non-human animals. The above features may provide auto-adjustment, which may be carried out in use and on the fly, of the PIR detector's ability to distinguish motion of pets or other animals from motion of humans.

The adjusting of the one or more parameters of the PIR detector that determine the ability or sensitivity of the PIR detector to detect non-human entities such as pets or other animals may comprise increasing a detection threshold of the PIR detector or reducing a gain of the PIR detector if it is determined from the output of the active reflected wave detector that the detection of motion by the PIR detector was due to detection of motion or presence of a pet or other non-human animal and no presence or motion of a human. Low energy infrared signals, resulting in a corresponding low amplitude of output from the pyroelectric sensor module, may be more likely to come from pets or other small non-human animals, so this operation may preferentially reduce the detection of such pets or other animals with less impact on the detection of humans.

The reduction of the gain or the increasing of the detection threshold may be selectively applied to the low frequency band and may not be applied to the high frequency band. The low frequency band and the high frequency band may be pre-defined. Low frequency signals outputted from the pyroelectric sensor module may be more likely to come from pets or other non-human animals, so this operation may preferentially reduce such unwanted detections with less impact on the detection of humans.

The system may be configured to determine a frequency or frequency band giving rise to the detection of motion by the PIR detector, e.g. for which it is subsequently determined that the detection arose due to motion of a pet or other non-human animal by the output of the active reflected wave detector meeting one or more criteria indicative of the presence or motion of a pet or other non-human animal and the absence of a human. The system may be configured to adjust the response of the PIR detector to the determined frequency or frequency band, e.g. by selectively reducing the gain and/or increasing the detection threshold for the determined frequency or frequency band, or by adjusting the one or more frequency bands of radiation that the PIR detector detects or is sensitive to so as to exclude the determined frequency or frequency band.

The adjusting of the one or more parameters of the PIR detector that determines the ability or sensitivity of the PIR detector to detect non-human entities such as pets or other animals may comprise increasing a lower limit of the frequency band that the PIR detector detects or is sensitive to, or by increasing a lower cut-off of a band-pass filter or high pass filter, which may filter the output of the pyroelectric sensor module of the PIR detector. Again, low frequency signals outputted from the pyroelectric sensor module may be more likely to come from pets or other non-human animals, so this operation may preferentially reduce such unwanted detections with less impact on the detection of humans.

The one or more criteria may be dependent on or indicative of a location of an entity represented in the output of the active reflected wave detector attributed to have caused the motion detected by the PIR detector. The attributed location may be an initial location of an entity, determined from the output active reflected wave detector, when the output active reflected wave detector is operated in response to the motion detected by the PIR detector. The one or more criteria may be dependent on or indicative of a distance to an entity represented in the output of the active reflected wave detector.

The system may be configured to implement a virtual fence, which may define the region of interest, for example a yard of a premises of or apart thereof. The virtual fence may correspond to at least part or all of a perimeter of the region of interest. The virtual fence may be user definable. The location of a property to be protected, e.g. a user's house, may be defined or definable relative to the virtual fence. For example, the virtual fence may define a region that abuts the property to be protected, e.g. the user's house. The system may be configured to determine presence or motion of entities within the virtual fence, e.g. within the region of interest.

The system may be configured to calculate a maximum distance corresponding to the region of interest, the maximum distance being a distance from the PIR detector to a furthermost location of the region of interest therefrom. The system may be configured to set a default value of the at least one parameter of the PIR detector, e.g. a range of the PIR detector or one or more parameter that determines a sensing range of the PIR detector, so that a default range of the PIR detector is based on said maximum distance. For example the default range of the PIR detector may be the same as said maximum distance.

The PIR detector and the active reflected wave detector may be held by a common housing. Thus the PIR detector and the active reflected wave detector may be essentially at the same location in the premises.

The system may be configured to adjust the sensing range of the PIR detector dependent on the location of the entity represented in the output of the active reflected wave detector attributed to have caused the motion detected by the PIR detector. A desired sensing range of the PIR detector may be correlated with the region of interest of the active reflected wave detector, e.g. the desired sensing range of the PIR detector may have a set or pre-determined correlation with the region of interest of the active reflected wave detector. The system may be configured to dynamically adjust the at least one parameter of the PIR detector based on the output of the active reflected wave detector to achieve or maintain the set or pre-determined correlation between the sensing range of the PIR detector and the region of interest of the active reflected wave detector.

The sensing range of the PIR detector may be substantially the same or bigger, e.g. by a set or pre-determined amount bigger, than the maximum distance from the PIR detector to a boundary point of the region of interest of the active reflected wave detector.

The system may be configured to perform an action, such as an alarm action or a deterrent action or a confirmation action such as triggering or operation of the active reflected wave detector when it is determined that an entity such as a human has entered or crossed the virtual fence.

The system may be configured to increase the sensing range of the PIR detector, e.g. by increasing a sensitivity or gain or reducing a detection threshold of the PIR detector, if the output of the active reflected wave detector indicates that an entity that is detected by the PIR detector to trigger the active reflected wave detector is within the virtual fence, e.g. by at least a threshold distance, when the active reflected wave detector is triggered. The entity may optionally be an object identified as being human, which may optionally be by failing a test aimed at identifying at least some non-human objects. The system may be configured to decrease the sensing range of the PIR detector, e.g. by decreasing a sensitivity or increasing a detection threshold of the PIR detector, if the output of the active reflected wave detector indicates that an entity (e.g. a human or non-human entity) that is detected by the PIR detector to trigger the active reflected wave detector is beyond the virtual fence, e.g. by at least a threshold distance, when the active reflected wave detector is triggered.

A second, outer region of interest may be defined beyond, but contiguous with, the virtual fence. The outer region of interest may be span between the virtual fence and an outer virtual fence. The outer region of interest may extend beyond the region of interest by a variable or set outer margin, which may be predefined. For example, the outer virtual fence may be parallel to and encompass or enclose the virtual fence.

The system may be configured to identify or distinguish between different scenarios relating to the position of an entity (e.g. a human entity) that is detected based on the active reflected wave detector upon being triggered by the PIR detector, the different scenarios comprising at least two or each of: the entity being outwith both the region of interest and the outer region of interest; the entity being within the outer region of interest; and the entity is within the region of interest.

The system may be configured to increase the sensing range of the PIR detector only when it is determined that the entity (e.g. a human entity) that is detected by the PIR detector to trigger the active reflected wave detector is within the region of interest bound by the virtual fence when the active reflected wave detector is triggered. The system may be configured to decrease the sensing range of the PIR detector only when it is determined that the entity (e.g. a human entity) that is detected by the PIR detector to trigger the active reflected wave detector is outwith both the region of interest and the outer region of interest when the active reflected wave detector is triggered. The system may be configured to maintain the sensing range of the PIR detector unchanged if the entity (e.g. a human entity) that is detected by the PIR detector to trigger the active reflected wave detector is within the outer region of interest. In this way, undesirable toggling of the sensing range of the PIR detector (e.g. rapid cycles of increases and decreases of the sensing range) may be more surely avoided.

The system may optionally be configured to increase the sensing range of the PIR detector to a default setting, e.g. a maximum setting for the premises, when it is determined that the entity (e.g. a human entity) that is detected by the PIR detector to trigger the active reflected wave detector is inside the region of interest when the active reflected wave detector is triggered. One reason this may be advantageous is that a person first being detected inside the region of interest may indicate that the person is attempting to avoid detection.

The system may be configured to increase and/or decrease the sensing range of the PIR detector by set or predefined amounts. The system may be configured to increase or decrease the sensing range by variable amounts, which may be dependent on one or more criteria. The criteria may be criteria based on the entity that is detected by the PIR detector to trigger the active reflected wave detector when the active reflected wave detector is triggered. For example the criteria may comprise criteria based on one or more or each of: the location of the entity determined by the active reflected wave detector when the active reflected wave detector is triggered, the speed of the entity determined by the active reflected wave detector when the active reflected wave detector is triggered, the direction of motion of the entity determined by the active reflected wave detector when the active reflected wave detector is triggered, the size of the entity determined by the active reflected wave detector and/or the like.

The system may be configured to determine, e.g. dynamically determine, the amount by which the sensing range of the PIR detector is to be increased and/or decreased from a look up table, by using at least one equation, or other mechanism for relating the amount by which the sensing range of the PIR detector is to be increased and/or decreased depending on the criteria being met. For example, the system may be configured to increase the sensing range by a greater amount if the entity is determined to be further insider the virtual fence when the active reflected wave detector is triggered.

The system may be configured to have a minimum sensing range of PIR detector, such that the sensing range cannot be decreased to less than the minimum sensing range. This may provide a safety mechanism against the sensing range being reduced to a dangerously low level that could compromise security of the premises.

The amount by which the sensing range of the PIR detector is to be increased and/or decreased may be determined at least partly on prior data, e.g. collected using other systems. The system may be configured to implement one or more counters for counting events or entities detected by the PIR detector and/or the active reflected wave detector. The system may be configured to adjust the at least one parameter of the PIR detector only when the counter reaches a predefined number greater than 1, such as 2, 3, 4 or more detections. The system may be configured to implement an asymmetric counter e.g. the system may require a greater number of detections for decreasing the sensing range of the PIR detector than for increasing, or vice versa. According to a second aspect of the present disclosure is a method of operating a monitoring system, the monitoring system comprising: a passive infrared, PIR, detector configured for detecting motion in an environment; and an active reflected wave detector arranged to measure wave reflections from a region of interest in the environment; wherein the method comprises: triggering or otherwise operating the active reflected wave detector responsive to detection of motion by the PIR detector; and adjusting at least one parameter of the PIR detector responsive to the output of the active reflected wave detector meeting one or more criteria.

The monitoring system may be a monitoring system according to the first aspect.

The at least one parameter of the PIR detector may define a controllable behavioural characteristic of the PIR detector that determines how the PIR detector responds to a moving infrared-light emitting object. The at least one parameter of the PIR detector may be a parameter that affects the operation of the PIR detector in determining motion. The at least one parameter of the PIR detector may be at least one parameter that determines, sets or defines a sensing range of the PIR detector, the sensing range being a maximum distance the PIR detector can reliably detect motion, e.g. to at least a predetermined or set level. The predetermined or set level may be a level indicative of typical motion of a human, for example within a certain range of weights, sizes and/or speeds typically associated with unassisted human motion. The predetermined or set level may be comprised in or indicative of a performance specification, which may be specified or specifiable, for example, by at least one of: a supplier, a manufacturer and/or a user. Therefore, beyond the sensing range, detection to the predetermined or set level may be unlikely and/or unguaranteed. The at least one parameter may be or comprise one or more detection thresholds, such as one or more thresholds that are used to determine whether a signal of the PIR detector, such as a signal output from the pyroelectric sensor module of the PIR detector, is indicative of motion.

The at least one parameter may comprise at least one parameter that defines one or more frequency bands of radiation that the PIR detector detects or is sensitive to, e.g. to meet the requirements of the performance specification.

The at least one parameter may comprise a gain of the PIR detector, which may define a level of gain applied by a gain stage of the PIR detector. The at least one parameter may comprise sensitivity of the PIR detector. The at least one parameter may comprise at least one parameter of a transfer function or gain vs frequency profile of the PIR detector.

The method may comprise adjusting the one or more parameter of the PIR detector only within a set or predetermined band or above, below and/or between one or more set or predetermined limits, e.g. upper and/or lower limits. The adjusting of the at least one parameter may be restrained to be one or more of: below an upper limit, above a lower limit and/or between the upper and lower limits.

The method may comprise automatically at least partially reversing or resetting the at least one parameter of the PIR detector with time, e.g. with time elapsed since a most recent instance of the output of the active reflected wave detector meeting the one or more criteria.

The one or more criteria may comprise an analysis of an output of the active reflected wave detector or output derived therefrom determining that the detected motion by the PIR detector was caused by a non-human entity, such as a pet or other non-human animal. The adjusting of the one or more parameters of the PIR detector may comprise adjusting one or more parameters of the PIR detector that determine the ability or sensitivity of the PIR detector to detect and/or identify non-human entities such as pets or other non-human animals.

The method may comprise adjusting the one or more parameter of the PIR detector may comprise increasing a detection threshold of the PIR detector or reducing a gain of the PIR detector if it is determined from the output of the active reflected wave detector that the detection of motion by the PIR detector was due to detection of motion or presence of a pet or other non-human animal and no presence or motion of a human. The method may comprise selectively applying the reduction of the gain or the increasing of the detection threshold to the low frequency band and may not be applied to the high frequency band.

The one or more criteria may be dependent on or indicative of a location of an entity represented in the output of the active reflected wave detector attributed to have caused the motion detected by the PIR detector. The attributed location may be an initial location of an entity, determined from the output active reflected wave detector, when the output active reflected wave detector is operated in response to the motion detected by the PIR detector. The one or more criteria may be dependent on or indicative of a distance to an entity represented in the output of the active reflected wave detector.

The method may comprise operating the system to implement a virtual fence, which may define the region of interest, for example a yard of a premises of or a part thereof.

The method may comprise calculating a maximum distance corresponding to the region of interest, the maximum distance being a distance from the PIR detector to a furthermost location of the region of interest therefrom. The method may comprise setting a default value of the at least one parameter of the PIR detector, e.g. a range of the PIR detector or one or more parameter that determines a sensing range of the PIR detector, so that a default range of the PIR detector is based on said maximum distance.

The method may comprise adjusting the sensing range of the PIR detector dependent on the location of the entity represented in the output of the active reflected wave detector attributed to have caused the motion detected by the PIR detector.

The method may comprise increasing the sensing range of the PIR detector, e.g. by increasing a sensitivity or gain or reducing a detection threshold of the PIR detector, if the output of the active reflected wave detector indicates that an entity that is detected by the PIR detector to trigger the active reflected wave detector is within the virtual fence, e.g. by at least a threshold distance, when the active reflected wave detector is triggered. The method may comprise decreasing the sensing range of the PIR detector, e.g. by decreasing a sensitivity or increasing a detection threshold of the PIR detector, if the output of the active reflected wave detector indicates that an entity (e.g. a human or non-human entity) that is detected by the PIR detector to trigger the active reflected wave detector is beyond the virtual fence, e.g. by at least a threshold distance, when the active reflected wave detector is triggered.

Optionally, increasing the sensitivity may comprise reducing a predetermined minimum number of detection threshold crossings required for the determining that motion has occurred. This facilities detecting motion of a person moving over a relatively smaller distance. Optionally, decreasing the sensitivity may comprise increasing a predetermined minimum number of detection threshold crossings required for the determining that motion has occurred. This generally results in a person needing to move further before motion is detected.

A second, outer region of interest may be defined beyond, but contiguous with, the virtual fence. The outer region of interest may span between the virtual fence and an outer virtual fence. The outer region of interest may extend beyond the region of interest by a variable or set outer margin, which may be predefined. For example, the outer virtual fence may be parallel to and encompass the virtual fence.

The method may comprise identifying or distinguishing between different scenarios relating to the position of an entity (e.g. a human entity) that is detected based on the active reflected wave detector upon being triggered by the PIR detector, the different scenarios comprising at least two or each of: the entity being outwith both the region of interest and the outer region of interest; the entity being within the outer region of interest; and the entity is within the region of interest.

The method may comprise increasing the sensing range of the PIR detector only when it is determined that the entity (e.g. a human entity) that is detected by the PIR detector to trigger the active reflected wave detector is within the region of interest bound by the virtual fence when the active reflected wave detector is triggered. The method may comprise decreasing the sensing range of the PIR detector only when it is determined that the entity (e.g. a human entity) that is detected by the PIR detector to trigger the active reflected wave detector is outwith both the region of interest and the outer region of interest when the active reflected wave detector is triggered. The method may comprise maintaining the sensing range of the PIR detector unchanged if the entity (e.g. a human entity) that is detected by the PIR detector to trigger the active reflected wave detector is within the outer region of interest.

The method may comprise increasing the sensing range of the PIR detector to a default setting, e.g. a maximum setting for the premises, when it is determined that the entity (e.g. a human entity) that is detected by the PIR detector to trigger the active reflected wave detector is inside the region of interest when the active reflected wave detector is triggered.

The method may comprise increasing and/or decreasing the sensing range of the PIR detector by set or predefined amounts. The method may comprise increasing or decreasing the sensing range by variable amounts, which may be dependent on one or more criteria. The criteria may be criteria based on the entity that is detected by the PIR detector to trigger the active reflected wave detector when the active reflected wave detector is triggered. For example the criteria may comprise criteria based on one or more or each of: the location of the entity determined by the active reflected wave detector when the active reflected wave detector is triggered, the speed of the entity determined by the active reflected wave detector when the active reflected wave detector is triggered, the direction of motion of the entity determined by the active reflected wave detector when the active reflected wave detector is triggered, the size of the entity determined by the active reflected wave detector and/or the like.

The method may comprise determining, e.g. dynamically determining, the amount by which the sensing range of the PIR detector is to be increased and/or decreased from a look up table, by using at least one equation, or other mechanism for relating the amount by which the sensing range of the PIR detector is to be increased and/or decreased depending on the criteria being met. For example, the method may comprise increasing the sensing range by a greater amount if the entity is determined to be further insider the virtual fence when the active reflected wave detector is triggered.

The method may comprise applying a minimum sensing range of PIR detector, such that the sensing range cannot be decreased to less than the minimum sensing range.

The method may comprise determining the amount by which the sensing range of the PIR detector is to be increased and/or decreased based at least partly on prior data, e.g. collected using other systems. The method may comprise counting events or entities detected by the PIR detector and/or the active reflected wave detector and adjusting the at least one parameter of the PIR detector only when the counter reaches a predefined number greater than 1, such as 2, 3, 4 or more detections. The method may comprise implementing an asymmetric counter e.g. the system may require a greater number of detections for decreasing the sensing range of the PIR detector than for increasing, or vice versa.

According to a third aspect of the present disclosure is a controller for a monitoring system, the controller being configured to implement the method of the second aspect. The controller may be configured to receive signals output from a passive infrared, PIR, detector configured for detecting motion in an environment. The controller may be configured to receive signals from an active reflected wave detector arranged to measure wave reflections from a region of interest in the environment. The controller may be configured to operate or trigger the active reflected wave detector responsive to detection of motion by the PIR detector. The controller may be configured to adjust at least one parameter of the PIR detector responsive to the output of the active reflected wave detector meeting one or more criteria.

According to a fourth aspect of the present disclosure is a computer program product configured such that, when run on a processing system or controller for a monitoring system, causes the processing system or controller to implement the method of the second aspect. The computer program product may be configured to cause the processing system or controller to: receive signals output from a passive infrared, PIR, detector configured for detecting motion in an environment; receive signals from an active reflected wave detector arranged to measure wave reflections from a region of interest in the environment; operate or trigger the active reflected wave detector responsive to detection of motion by the PIR detector; and adjust at least one parameter of the PIR detector responsive to the output of the active reflected wave detector meeting one or more criteria.

The computer program product may be embodied on a non-transient physical computer readable medium.

The individual features and/or combinations of features defined above in accordance with any aspect of the present disclosure or below in relation to any specific embodiment of the disclosure may be utilised, either separately and individually, alone or in combination with any other defined feature, in any other aspect or embodiment of the disclosure.

Furthermore, the present disclosure is intended to cover apparatus configured to perform any feature described herein in relation to a method and/or a method of using or producing, using or manufacturing any apparatus feature described herein.

### BRIEF DESCRIPTION OF THE SEVERAL VIEWS OF THE DRAWINGS

For a better understanding of the present disclosure and to show how embodiments may be put into effect, reference is made to the accompanying drawings in which:

FIG. 1 is a schematic representation of a monitoring system;

FIG. 2 is a schematic representation of a passive infrared (PIR) detector of the monitoring system of FIG. 1;

FIG. 3 is a flowchart illustrating a method of operating the monitoring system of FIG. 1;

FIG. 4 is a flowchart illustrating a detailed example of the method of FIG. 3;

FIG. 5 is a schematic illustration of an area monitored by the monitoring system of FIG. 1;

FIG. 6 is a schematic illustration of the area illustrated in FIG. 5 with respect to the location of an entity when an active reflected wave detector of the monitoring system is triggered by a PIR detector;

FIG. 7 is a flowchart illustrating another detailed example of the method of FIG. 3;

FIG. 8 is an illustration of a gain vs frequency profile of a PIR detector of the system of FIG. 1 indicating regions associated with detection of pets and humans; and

FIG. 9 is a flowchart illustrating a further detailed example of the method of FIG. 3.

### DETAILED DESCRIPTION

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized, and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims and their equivalents.

In the following embodiments, like components are labelled with like reference numerals.

In the following embodiments, the term data store or memory is intended to encompass any computer readable storage medium and/or device (or collection of data storage mediums and/or devices). Examples of data stores include, but are not limited to, optical disks (e.g., CD-ROM, DVD-ROM, etc.), magnetic disks (e.g., hard disks, floppy disks, etc.), memory circuits (e.g., EEPROM, solid state drives, random-access memory (RAM), etc.), and/or the like.

As used herein, except wherein the context requires otherwise, the terms “comprises”, “includes”, “has” and grammatical variants of these terms, are not intended to be exhaustive. They are intended to allow for the possibility of further additives, components, integers or steps.

The functions or algorithms described herein are implemented in hardware, software or a combination of software and hardware in one or more embodiments. The software comprises computer executable instructions stored on computer readable carrier media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, FPGA, microprocessor, microcontroller or other type of processing device or combination thereof.

Specific embodiments will now be described with reference to the drawings.

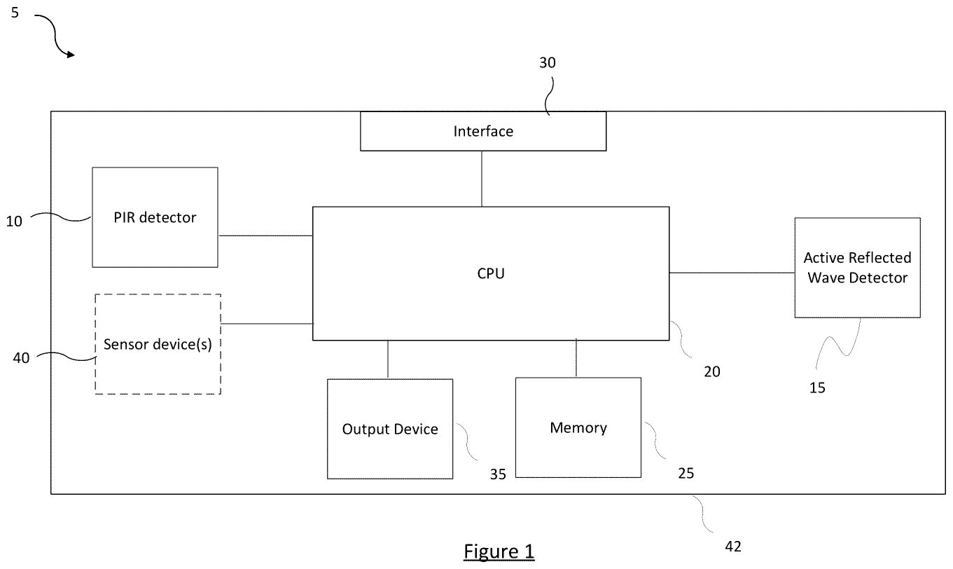

FIG. 1 is a schematic of a monitoring system 5 that comprises a passive infrared (PIR) detector 10 that is configured to detect motion of an entity, particularly a human entity, in an environment. The monitoring system 5 further comprises an active reflected wave detector 15 that is configured to emit waves of radiation into the environment and to detect reflections of the emitted radiation from entities in the environment. The active reflected wave detector 15 is a ranging device configured to determine a distance from the active reflected wave detector 15 to the entity using the detected reflections of the emitted radiation. Techniques such as, but not limited to, time of flight or other suitable ranging technique can be used for this purpose.

The monitoring system 5 also comprises a processing system 20 operable to receive signals indicative of detected motion from the PIR detector 10 and signals indicative of the distance and bearing to any detected entities from the active reflected wave detector 15. The processing system 20 shown in FIG. 1 comprises a central processing unit (CPU) but could comprise alternative or additional components such as an FPGA, ASICS, a graphics processing unit (GPU), a math co-processor, a tensor processing unit (TPU) or other algorithm specific processing unit, and/or the like. The processing system 20 is operable to control (e.g. to trigger or wake) the active reflected wave detector 15 responsive to a signal indicative of detection of motion from the PIR detector 10.

The monitoring system 5 also comprises a memory 25 for storing at least computer readable code that programs the processing system 20, an interface 30 for interfacing with a hub (not shown) or other monitoring systems 5 and an output device 35, such as an alarm sounder, a deterrent device such as a fogger or the like. The monitoring system 5 optionally also comprises a further sensor device 40, such as a camera or the like, that may also be operable responsive to detection of motion.

The monitoring system 5 is configured such that the PIR detector 10 remains active to detect and identify motion, particularly human motion, in the environment. In contrast, the active reflected wave detector 15 is usually in a lower power state (e.g. switched off or in a sleep mode) by default whilst no moving entities are detected in the environment by the PIR detector 10. The monitoring system 5 is configured to trigger the active reflected wave detector 15, i.e. switch it from the lower power state into an active state in which it collects ranging information to entities, responsive to detection of motion in the environment by the PIR detector 10. In this way, the monitoring system 5 can reduce the amount of power that it uses by having the active reflected wave detector 15 default to the lower power state, using the PIR detector 10 to monitor for motion of an entity and triggering the active reflected wave detector 15 to exit the low power state into the active state when human motion is detected by the PIR detector 10.

In the example of FIG. 1, components such as at least the PIR detector 10, the active reflected wave detector 15, and the processing system 20, and optionally also the output device 35, memory 25, interface 30 and further sensor devices 40, are all incorporated in a single device, e.g. provided in a common housing 42. However, in other examples, one or more or each of these components can be provided in separate devices, and are optionally spaced apart and/or provided at different locations. Furthermore, the monitoring system 5 of FIG. 1 is preferably battery powered and the interface configured for wireless communications. This allows for easier installation and greater freedom in fitting but at the expense of limited power storage.

The monitoring component 5 can have a range of possible applications. One application is as a monitoring component of an alarm or intruder system. In this case, the alarm or intruder system may be configured to raise an alarm and/or transmit an alert notification and/or to instigate other actions such as operating a camera and/or microphone or deploying deterrent measures such as operating a fogger or the like, responsive to a determination of the motion or presence of a human entity based on the output of the active reflected wave detector 15. However, such monitoring components can alternatively be used in a range of other systems or serve other purposes.

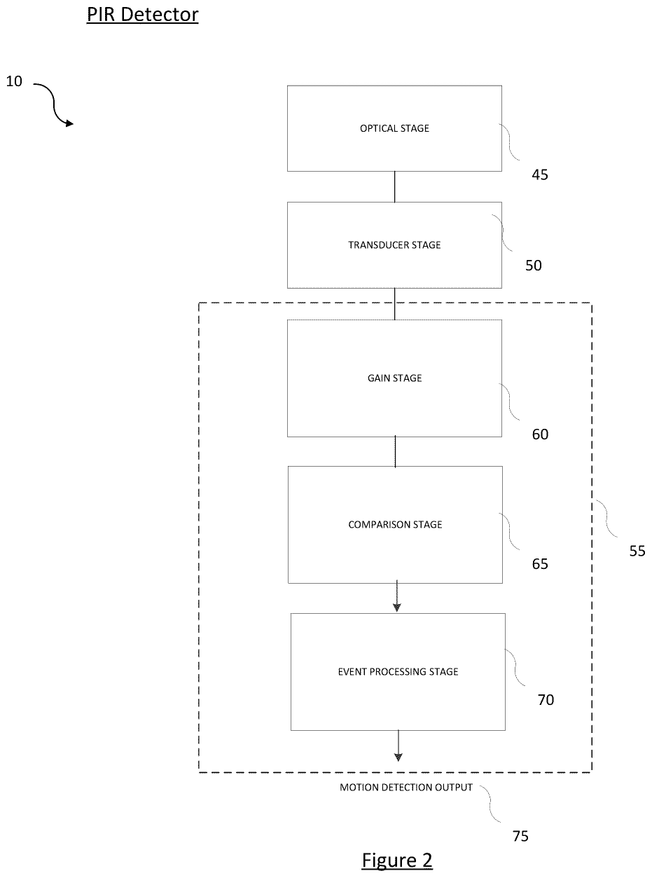

Exemplary functional stages of the PIR detector 10 are shown in FIG. 2. These are provided by way of example, and it will be appreciated that other arrangements of PIR detector could be used.

In this example, the PIR detector 10 comprises an optical stage 45 for providing an optical signal indicative of received IR radiation, a transducer stage 50 for transducing the optical signal provided by the optical stage 45 into an electrical signal, and a processing stage 55 for processing the electrical signal to determine whether or not the signal is indicative of motion (e.g. of human motion).

In examples, the optical stage 45 comprises a lens array formed from material that is transparent to IR radiation, wherein the lens array comprises an array of Fresnel lenses. The lens array may be in the shape of a dome, or in the shape of a hemicylindrical sheet and/or a half-dome. The Fresnel lenses are typically arranged in rows, wherein a greater number of Fresnel lenses are provided in the rows at the top than at the bottom, and the lenses at the top are configured to capture IR radiation from entities further away and the lenses at the bottom are configured for capturing IR radiation from entities closer to, and more beneath, the PIR detector 10. The arrangement of the lens array may be considered as defining an optical transfer function that defines a transformation of moving IR radiation received at the optical stage 45 to the IR radiation signal provided to the transducer stage 50.

The transducer stage 50 is configured to receive the IR radiation from the optical stage 45 (specifically from the Fresnel lenses) and convert the IR radiation into at least one corresponding electrical signal. The transducer stage 50 could comprise, for example a pyroelectric sensor having positive and negative pyroelectric sensor elements each having a different field of view, and configured to output the electrical signal indicative of IR radiation received from the optical stage 45.

The processing stage 55 receives the electrical signal from the transducer stage 50 and is configured to determine if the electrical signal is indicative of motion, e.g. motion of a human. The processing stage 55 comprises a gain stage 60, a comparison stage 65 and an event processing stage 70.

The gain stage 60 applies a gain to the electrical signal from the transducer stage 50. The gain stage 60 has a gain and frequency response profile that may be represented by a gain-stage transfer function. The gain may be modified uniformly across all frequencies or by changing the frequency response profile to have higher or lower gain at some frequencies compared with other frequencies. It will be appreciated that the gain stage may be implemented by analog and/or digital electronics, and/or in software, using any technique known by the person skilled in the art.

The output from the gain stage 60 is provided to the comparison stage 65 that compares the output from the gain stage 60 to one or more thresholds in order to identify occurrences of the output of the gain stage exceeding one or more thresholds. The comparison may be performed by electronics or in software. The comparison may be with respect to a single threshold. This may be the case, for example, where the output of the gain stage 60 is an absolute value. In other embodiments, a positive and a negative thresholds may respectively be used to compare the output of the gain stage 60. Further, optionally different thresholds may be used for different frequency ranges.

The event processing stage 70 receives indications of the respective threshold-crossing occurrences identified by the comparison stage 65 and applies defined or predefined logic specifying one or more conditions to be met to give a determination of the presence of motion, e.g. motion of a human, or otherwise. If the occurrences of threshold-crossings identified by the comparison stage 65 meet the conditions, then a signal indicative of motion detection 75 is output from the event processing stage 70. If the occurrences of threshold-crossings identified by the comparison stage 65 do not meet the conditions, then it is determined that no motion, e.g. motion of a human, is present. An example condition is that there must be more than a predetermined number of threshold crossings within a predefined time window. For example, the predetermined number N may be greater than 1 (e.g. 2 or 3) to aid against identifying noise as motion. The predefined time window (T), may optionally be correlated with the low frequency cut-off (fc) of the PIR's frequency response, for example such that N/fc<T.

The PIR detector 10 requires a relatively low amount of power to operate compared to the active reflected wave detector 15. However, the active reflected wave detector 15 can be capable of different types of detection to the PIR detector 10, for example being able to determine presence of the entity irrespective of whether the entity is moving location and/or to determine distance and/or bearing to the detected entity and may optionally thereby determine direction of travel and/or velocity of the detected entity. The distance and/or bearing may be used to determine the entity's location relative to a region of interest. In contrast, the PIR detector 10 is generally capable of determining whether or not there is motion, such as motion of a human, but cannot determine position of entity. Having the PIR detector 10 active and capable of detecting motion but the active reflected wave detector 15 by default in the low power, e.g. inactive, state until motion is detected by the PIR detector 10 can beneficially result in the active reflected wave detector 15 being active and capable of detecting the entity only when required. This arrangement allows the different measurements, such as range, position, direction of travel and/or velocity of travel to be determined without excessive drain on power, which is particularly important in battery powered monitoring systems 5.

However, the present inventors have identified that the combination of the PIR detector 10 and the active reflected wave detector 15 can be used to leverage further benefits. For example, the operation of the PIR detector 10 involves use of certain parameters to determine whether or not motion, such as motion of a human, is present. These parameters could include, for example, a gain and/or frequency response profile (i.e. gain vs frequency profile) applied at the gain stage 60, the threshold or thresholds applied by the comparison stage 65, or the predetermined number N of threshold crossings of the event processing stage, each of which affect the sensitivity of the PIR detector 10 to detecting motion. However, the above are not intended to be an exhaustive list and there could be other parameters used to determine whether or not motion, such as motion of a human, is present using the PIR detector 10.

The present inventors have identified that the different or more accurate measurements that are possible using the active reflected wave detector 15 can be used to adjust or refine the values of the parameters used to determine whether or not motion, such as motion of a human, is present using the PIR detector 10. Such adjustments or refinements can be done on the fly in real time or near real time and in the field. This allows, amongst other benefits, the peculiarities of the location and specific use conditions of the monitoring system 5 in the field to be taken into account. For example, the response of the PIR detector 10 may be different for different environments, or the response could be different on hot sunny days to cold nights. Furthermore, functions intended to distinguish humans from pets may vary in response between large and small pets and could be adapted to the specific pets owned by the owners of the particular monitoring system 5. However, there may be other factors that could influence the operation of the PIR detector 10 in specific circumstances and use scenarios. By providing an adaptive PIR detector 10 in which the parameters used to determine whether or not motion, such as motion of a human, is present using the PIR detector are adjusted on the fly and in use using the active reflected wave detector 15, the PIR detector can be configured according to its current environment.

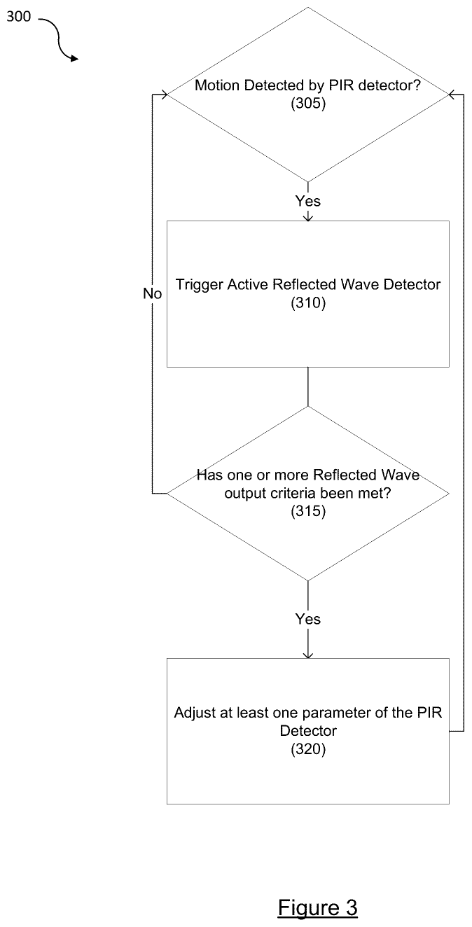

FIG. 3 is a flowchart giving an overview of a method 300 of operating of the monitoring system 5 in order to dynamically modify one or more of the parameters of the PIR detector 10. The method 300 can be implemented, for example, by the processing system 20 shown in, and described in relation to, FIG. 1 but is not limited to this and one or more of the identified steps could be provided by remote, external processing resource, for example.

In a default state, the PIR detector 10 is active and capable of detecting motion whilst the active reflected wave detector 15 is in a low power state in which it doesn't detect presence or motion.

In step 305, it is identified if motion of at least one entity, such as motion of a human, has been identified by the PIR detector 10. If motion has been detected by the PIR detector 10 then, in step 310, the active reflected wave detector 15 is triggered, i.e. switched from the low power state into an active state in which it can detect an object that may have caused the identified motion and the position of the object. Outputs of the active reflected wave detector 15 can comprise, or be usable to determine, one or more properties of the entity, such as one or more of the properties selected from a group comprising: presence of the entity, distance from the active reflected wave detector 15 to the entity, a bearing from the active reflected wave detector 15 to the entity, velocity of the entity, direction of travel of the entity, size of the entity, and/or the like.

In step 315, at least one of the outputs of the active reflected wave detector 15 can be compared to one or more reflected wave output criteria that determine whether at least one of the parameters of the PIR detector should be adjusted and, if so, how it should be adjusted. For example, the processing system 20 could be configured to access a look-up-table, algorithm, model or other relational arrangement that specifies the one or more reflected wave output criteria and an associated adjustment that should be made to the at least one of the parameters of the PIR detector if the respective reflected wave output criteria are met.

If any of the respective reflected wave output criteria are met, then the method proceeds to step 320 in which the at least one parameter of the PIR detector is adjusted by the adjustment associated with the respective reflected wave output criteria that have been met. If none of the respective reflected wave output criteria are met, then the method returns to 305 in which the output of the PIR detector 10 is monitored for motion being detected.

Variations of the above method are possible. In one example, the one or more parameter of the PIR detector 10 can be adjustable only within a set or predetermined band or above, below and/or between one or more set or predetermined upper and/or lower limits. In this way, the adjustment of the at least one parameter of the PIR detector 10 is restrained to be below an upper limit, above a lower limit and/or between the upper and lower limits. These features may avoid a situation where the sensing range of the PIR detector 10 is undesirably reduced to a very low level in which detection is unlikely to take place unless the entity is undesirably close to the PIR detector 10 and/or when the PIR detector is made too sensitive and prone to false positives/false detections.

In an example, any adjustment to the at least one parameter is temporary. For example, the monitoring system 5 may be configured to automatically at least partially reverse or reset the at least one parameter of the PIR detector upon at least one timing criteria being met. The example, the at least partial reversing or resetting may occur with time elapsed since a most recent instance of the output of the active reflected wave detector 15 meeting one of the reflected wave output criteria. The reversal could be gradual over time, or could involve a step change, which may occur upon commencement of a period of the day (e.g. night-time), at a set time (e.g. 9 pm) or after a set or preset time since a most recent instance of the output of the active reflected wave detector 15 meeting one of the reflected wave output criteria. This could prevent temporary events, for example a large animal running through the sensing region or a non-threatening person or people temporarily engaging in an activity in an outer part of the sensing region that is beyond the premises, leading to a prolonged adjustment of the at least one parameter of the PIR detector 10 in a way that may be less suited to the long-term or typical situation.

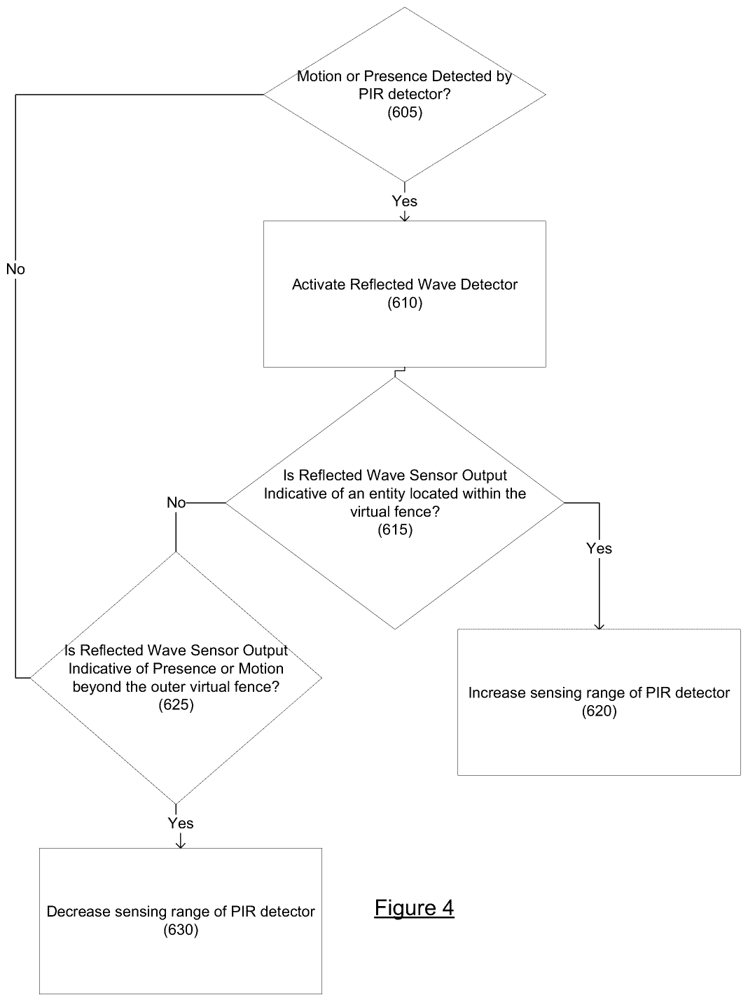

There are various ways in which the method of FIG. 3 can be applied. FIG. 4 shows one example in which the parameters of the PIR detector are adjusted to adjust the triggering point of the active reflected wave detector 15 depending on the location of the entity when the active reflected wave detector 15 is triggered relative to a virtual fence.

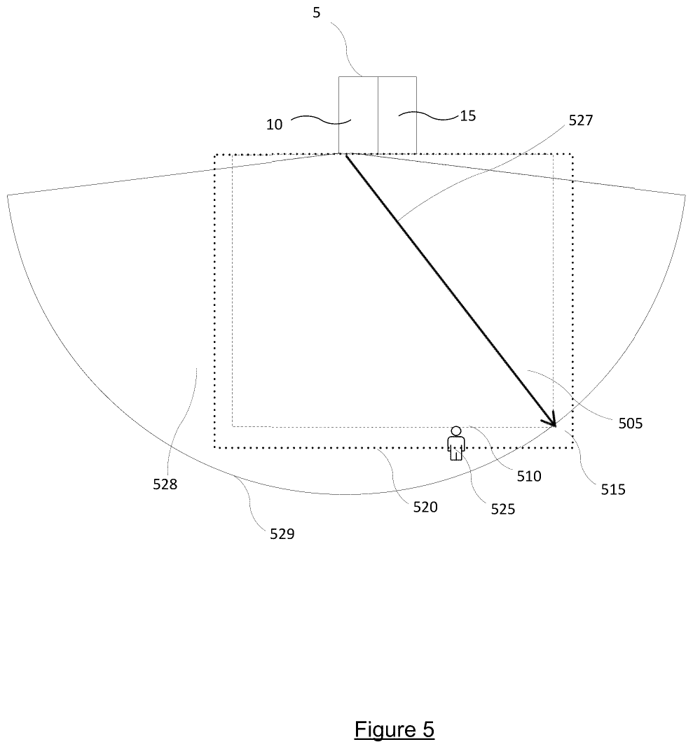

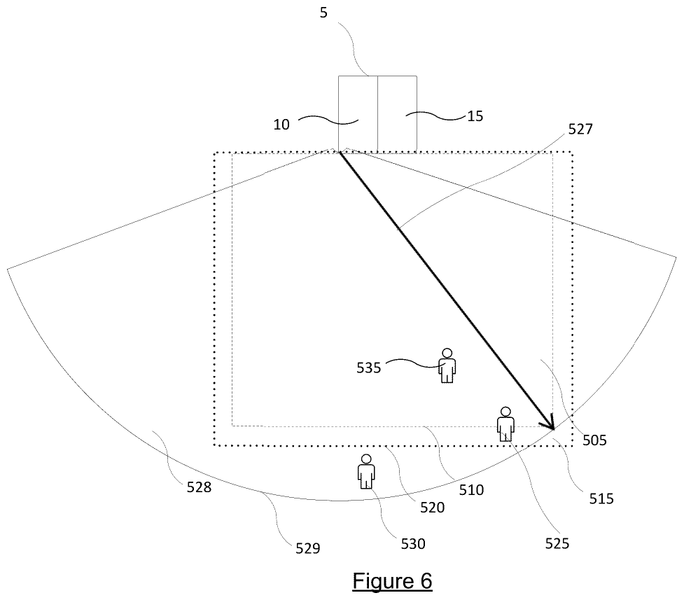

As shown in FIGS. 5 and 6, the active reflected wave detector 15 is configured to detect entities within a region of interest 505. At least part of the region of interest 505 can be defined by one or more virtual fences 510 that define at least part of the perimeter of the region of interest 505. For example, as shown in the illustrated examples, the region of interest 505 is bound by the virtual fence 510.

The region of interest of the active reflected wave detector 15 can be bound by a field of view and a depth of view of the active reflected wave detector 15, or may be a region defined therein. Exemplary methods for an installer to define such a virtual fence is described in International patent application number PCT/IL2020/050130, filed 4 Feb. 2020, the contents of which are incorporated herein by reference. However, other methods of defining a virtual fence may alternatively be employed. It will be appreciated that more than one virtual fence may be defined within the field of view of the active reflected wave detector. The region of interest may be defined on a case-by-case basis at installation, depending on the use case, e.g. the environment in which it is installed. However, other methods of defining the virtual fences 510 could alternatively be employed. The one or more virtual fences 510 could be defined at manufacture of the monitoring system 5 but more beneficially could be defined either as part of the installation on site or defined by a user, e.g. using a control app or other system software, so as to tailor the one or more virtual fences 510 and thereby the region of interest 505 to the specific property at which the monitoring system 5 is installed. Alternatively, the virtual fence 510 could be defined by a user walking and/or moving a reflective marker where the user wishes the virtual fence 510 to be as part of a configuration mode. The specification of the one or more virtual fences 510 allows the region of interest 505 that is probed by the active reflected wave detector 15 to be configured to correspond to the wishes of the user or to match a boundary or other part of a property to be protected.

In some examples an outer region of interest 515 can be defined around and located outside the desired region of interest 505 such that the outer perimeter of the outer region of interest 515 is spaced apart from the desired region of interest 505 by a margin. The perimeter of the outer region of interest 515 can be defined by one or more outer virtual fences 520. The outer region of interest may span between the virtual fence 510 and the outer virtual fence 520.

Ideally, the PIR detector 10 should be configured to trigger the active reflected wave detector 15 just as an entity is crossing the virtual fence 510 or is within the margin between the outer virtual fence 520 and the virtual fence 510, such as that indicated by entity location 525 in FIGS. 5 and 6. If the active reflected wave detector 15 is triggered when the entity is beyond the outer virtual fence 520, such as the entity location 530 shown in FIG. 6, then excess power consumption may arise and the monitoring system may be susceptible to false triggers by entities that won't enter the region of interest. In other words, the active reflected wave detector 15 would have been needlessly activated since the person did not enter the region of interest 505. Conversely, if the active reflected wave detector 15 is triggered when the entity has already crossed the virtual fence 510 into the region of interest 505, such as the entity location 535 shown in FIG. 6, then any required action to be taken responsive to a detection of an entity, such as sounding an alarm, could be undesirably delayed.

As such, it may, at least sometimes and/or for some environments, be appropriate to have a sensing or detection range of the PIR detector 10 being equal to a maximum distance 527 from the PIR detector 10 to a furthermost location of the region of interest 505. The parameters of the PIR detector 10 that are adjusted may be parameters that at least partially set or define the detection range of the PIR detector 10. The sensing or detection range of the PIR detector 10 is a maximum distance the PIR detector 10 can detect motion of an entity, e.g. a human entity, to at least a predetermined or set level. A sensing area 528 of the PIR detector 10 is an area up to a segment of an arc 529 centered on the PIR detector 10 and with a radius corresponding to the sensing or detection range of the PIR detector 10.

In the method of FIG. 4, in a default state, the PIR detector 10 is active and capable of detecting motion and the active reflected wave detector 15 is in a low power state in which it doesn't detect presence or motion.

In step 605 it is identified if motion of at least one entity, such as motion of a human, has been identified by the PIR detector 10. If motion has been detected by the PIR detector 10, then the active reflected wave detector 15 is triggered, i.e. switched from the low power state into an active state in which it can detect presence or motion. The active reflected wave detector 15 is then operated to detect the entity whose motion was identified by the PIR detector 10 to trigger the active reflected wave detector 15. This step is equivalent to step 305 in FIG. 3.

In this example, the output of the active reflected wave detector 15 is indicative of a location of the at least one entity whose motion was detected by the PIR detector 10 to trigger the active reflected wave detector 15. The location could, for example, comprise two dimensional coordinates, or more beneficially three dimensional coordinates, which may for example define a bearing and distance of the at least one entity from the active reflected wave detector 15 or cartesian coordinates of the at least one entity with respect to the active reflected wave detector 15. The location of the entity can be determined by the active reflected wave detector 15 as it is a ranging device, in contrast to the PIR detector 10 that determines whether motion is present or not and does not determine the location of an entity.

In step 615 it is determined if the location of the at least one entity determined by the active reflected wave detector 15 on triggering is within the virtual fence 510. If it is, then the at least one parameter of the PIR detector 10 is adjusted so as to increase the sensing range of the PIR detector 10 in step 620, e.g. by increasing a gain of the gain stage 60, by increasing sensitivity, by reducing one or more thresholds used in the comparison stage 65, and/or the like.

In step 625 it is determined if the location of the at least one entity determined by the active reflected wave detector 15 on triggering is beyond the outer virtual fence 520. If it is, then the at least one parameter of the PIR detector 10 is adjusted so as to decrease the sensing range of the PIR detector 10 in step 630, e.g. by decreasing a gain of the gain stage 60, by decreasing sensitivity, by increasing one or more thresholds used in the comparison stage 65, and/or the like.

It will be appreciated from the above that, if the monitoring system 5 determines that the location 525 of the at least one entity determined by the active reflected wave detector 15 considered to have caused the PIR detector 10 to trigger the active reflected wave detector 15 is between the outer virtual fence 520 and the virtual fence 510 then the at least one parameter of the PIR detector 10 is maintained at its current value.

By having a margin at the region of interest 505 (i.e. the area between the virtual fence 510 and outer virtual fence 520) in which an entity causing a triggering of the active reflected wave detector 15 can be located without leading to an adjustment of the at least one parameter, unwanted toggling of the sensing range of the PIR detector 10 (e.g. rapid cycles of increases and decreases of the sensing range, especially while a person is located at the virtual fence 510) may be avoided or reduced.

In examples, the monitoring system 5 is configured to identify the maximum distance 527 corresponding to the region of interest 505, the maximum distance 527 being a distance from the PIR detector 10 to a furthermost location of the region of interest 505 therefrom. The maximum distance 527 may thus be calculated as being the furthermost location on the virtual fence 510 from the PIR detector 10. In examples, the monitoring system 5 is configured to set a default value of the at least one parameter of the PIR detector 10, e.g. the sensing or detection range of the PIR detector 10 or one or more parameter that determines the sensing or detection range of the PIR detector 10, so that a default sensing or detection range of the PIR detector 10 is based on or equal to said maximum distance.

In effect, a desired sensing range of the PIR detector 10 is correlated with the region of interest 505 of the active reflected wave detector 15, e.g. so that the desired sensing range of the PIR detector 10 is equal to, or larger by a set or preset amount than, the distance from the PIR detector 10 to a furthermost location of the region of interest 505 therefrom. The adjustments of the at least one parameter of the PIR detector 10 that affects the sensing range of the PIR detector 10 seek to dynamically adjust the sensing range of the PIR detector 10 towards the desired sensing range.

In some examples, the amount that the one or more parameters and thereby the sensing range of the PIR detector 10 is adjusted by is set or predefined. In other examples, the amount that the one or more parameters and thereby the sensing range of the PIR detector 10 is adjusted by is variable, for example, by being dependent on one or more criteria. The criteria are optionally based on the location of the entity determined by the active reflected wave detector when the active reflected wave detector is triggered. For example, the further inside the region of interest 505 that the entity causing the triggering of the active reflected wave detector 15 is located, as determined by the active reflected wave detector 15 upon being triggered, the greater the amount that the sensing range of the PIR is increased by. The amount by which the one or more parameters and thereby the sensing range of the PIR detector 10 is adjusted can be dynamically determined from a look up table, by using at least one equation, or other mechanism for relating the amount by which the sensing range of the PIR detector is to be increased and/or decreased depending on the criteria being met.

In examples, the monitoring system 5 is optionally configured to implement a minimum sensing range of PIR detector 10, such that the sensing range cannot be decreased to less than the minimum sensing range. This provides a safety mechanism against the sensing range being reduced to a dangerously low level that could compromise security of the premises.

In examples, the monitoring system 5 is configured to implement a counter for counting events or entities detected by the PIR detector 10 and/or the active reflected wave detector 15. In this case, the at least one parameter of the PIR detector 10 is adjusted responsive to the output of the active reflected wave detector meeting one or more criteria only when the counter reaches a predefined number greater than 1, such as 2, 3, 4 or more detections. In examples, the counter is an asymmetric counter e.g. to be conservative, the number of motion detection events required for decreasing the sensing range of the PIR detector could be greater than the number of detections required for increasing. The use of the counter can help avoid undesirable toggling by only adjusting the at least one parameter responsive to persistent or repeated triggering detections in locations other than the desired region between the outer virtual fence 520 and the virtual fence 510. Furthermore, the asymmetric counter could help avoid over reducing the sensing range of the PIR detector 10, which could otherwise result in failures to detect an intruding entity in sufficient time.

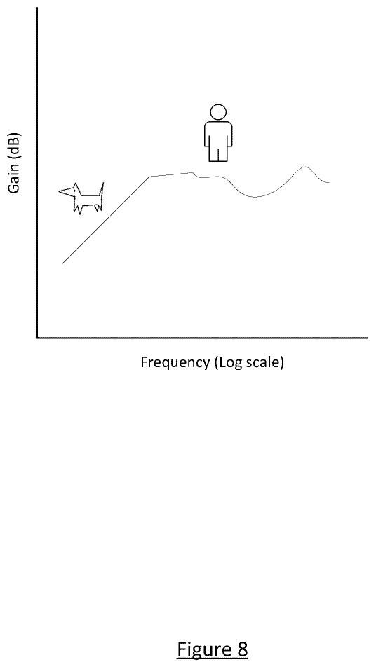

In examples, the at least one parameter of the PIR detector 10 is only adjusted if the detected motion is determined to be motion of a human or at least not motion of a pet. The monitoring system 5 can optionally comprise a classifier that classifies the output of the active reflected wave detector 10. For example, the classifier can determine if the output of the active reflected wave detector 15 is indicative of presence or motion of a human or if the output of the active reflected wave detector 15 is indicative of presence or motion of the non-human entity, such as a pet or other animal. For example, the determination of whether the motion is due to a human or there is no motion due to a human present may be based on the frequency or frequency range associated with the detection, wherein lower frequencies can be associated with pet motion, and a higher frequency range or band can be associated with human motion, as illustrated in FIG. 8. In examples, the classifier could determine a speed or velocity of motion of the entity, with there being a defined upper limit of speed or velocities associated with humans. However, the above are only provided as examples and other techniques (including techniques known to the person skilled in the art) for distinguishing human motion form non-human, e.g. pet, motion could be used.

Although an example of adjusting the at least one parameter of the PIR detector 10 to adjust the sensing range of the PIR detector 10 is described above, other techniques that follow the general process shown in, and described in relation to, FIG. 3 are envisaged.

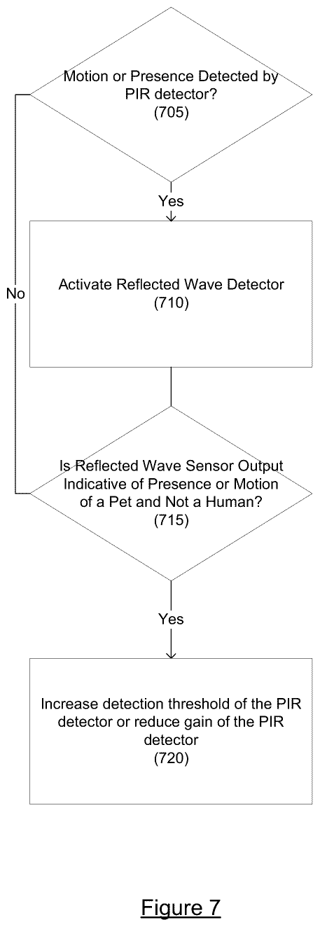

FIGS. 7 to 9 illustrate another technique in which at least one parameter that is adjusted responsive to the output of the active reflected wave detector 15 is at least one parameter that distinguishes output of the PIR detector 10 associated with motion of humans from output resulting from the motion of pets.

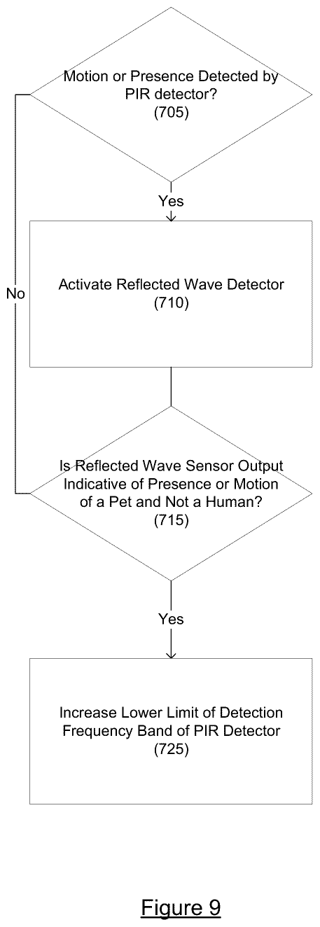

In the examples of FIGS. 7 and 9, in a default state, the PIR detector 10 is active and capable of detecting motion and the active reflected wave detector 15 is in a low power state in which it doesn't detect presence or motion.

FIGS. 7 and 9 are flowcharts illustrating steps of a method of operating the motion detector 5 to dynamically adjust the at least one parameter that distinguishes output of the PIR detector 10 associated with motion of humans from output resulting from the motion of pets.

In step 705 of FIG. 7, which is equivalent to step 310 in FIG. 3, it is identified if motion of at least one entity, such as motion of a human, has been identified by the PIR detector 10. If motion has been detected by the PIR detector 10, then the active reflected wave detector 15 is triggered, i.e. switched from the low power mode into an active mode in which it can detect present or motion in step 710. The active reflected wave detector 15 is then operated to detect the entity whose motion was identified by the PIR detector 10.

The active reflected wave detector 15 is operable to characterise the entity. For example, unlike the PIR detector 10, the active reflected wave detector 15 can more accurately determine properties of the entity such as size, speed or velocity, spatial configuration with respect to the ground, and/or the like, wherein the values of these properties can be indicative or humans or pets. In addition, pets may give rise to lower frequency reflections of the radiation emitted by the active reflected wave detector 15 than humans, as illustrated in FIG. 8, such that a frequency profile of the reflected radiation received by the active reflected wave detector 15 can be indicative of human motion, pet motion, or both. As such, the monitoring system 5 can comprise the classifier described above to distinguish between pet motion, human motion or both based on the output of the active reflected wave detector 15.

In step 715 of FIG. 7, it is determined if the output of the active reflected wave detector 15 arising from the entity whose motion was detected by the PIR detector 10 to trigger the active reflected wave detector 15 is indicative of a pet and not a human. After all, as will be appreciated, though the PIR detector 10 is configured to detect human motion, some non-human motion could be confused as being human motion. If the output of the active reflected wave detector 15 arising from the entity whose motion was detected by the PIR detector 10 to trigger the active reflected wave detector 15 is indicative of a pet and not a human (i.e. the answer from step 715 is ‘yes’), then in step 720 at least one parameter of the PIR detector that can be used to distinguish, or increase distinction, between pets and humans is adjusted accordingly, so as increase immunity to pet detection. For example, one or more detection thresholds of the PIR detector could be increased (lower amplitude signals may be more likely associated with pets than humans) or a gain of the PIR detector 10 could be reduced. If the output of the active reflected wave detector 15 arising from the entity whose motion was detected by the PIR detector 10 to trigger the active reflected wave detector 15 is not indicative of a pet or indicative of a pet but also indicative of a human (i.e. the answer from step 715 is ‘no’), then the at least one parameter of the PIR detector 10 that can be used to distinguish between pets and humans is not adjusted.

A variation in the process of FIG. 7 is shown in FIG. 9. The process of FIG. 9 comprises the same steps 705 to 715 as FIG. 7. However, if the output of the active reflected wave detector 15 arising from the entity whose motion was detected by the PIR detector 10 to trigger the active reflected wave detector 15 is indicative of a pet and not a human (i.e. the answer from step 715 is ‘yes’), then the parameter that is adjusted in step 725 is a lower limit of a detection frequency band of the PIR detector 10, i.e. the lower limit of the detection frequency band of the PIR detector 10 is increased. As noted above, the motion of pets is generally associated with lower frequencies than human motion and so increasing the lower limit of the detection frequency band of the PIR detector 10 can help to exclude detections associated with pets.

Various features described above in relation to the embodiment of FIG. 4, such as counters, and the adjustment of the at least one parameter of the PIR detector 10 being gradual or as a step change, or to no more than a predefined maximum, or being by a set or pre-set amount, or by a dynamically determined amount that is determined based on the output of the active reflected wave detector 15 (e.g. based on a confidence score provided by a classifier that classified that the entity as a pet and not a human).

The above examples are provided by way of illustrating how the invention might be put into practice, but other implementations could be provided that fall within the scope of the claims.

Method steps of the invention can be performed by one or more programmable processors executing a computer program to perform functions of the invention by operating on input data and generating output. Method steps can also be performed by special purpose logic circuitry, e.g., an FPGA (field programmable gate array) or an ASIC (application-specific integrated circuit) or other customised circuitry. Processors suitable for the execution of a computer program include CPUs and microprocessors, and any one or more processors. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g. EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the invention can be implemented on a device having a screen, e.g., a CRT (cathode ray tube), plasma, LED (light emitting diode) or LCD (liquid crystal display) monitor, for displaying information to the user and an input device, e.g., a keyboard, touch screen, a mouse, a trackball, and the like by which the user can provide input to the computer. Other kinds of devices can be used, for example, feedback provided to the user can be any form of sensory feedback, e.g., visual feedback, auditory feedback, or tactile feedback; and input from the user can be received in any form, including acoustic, speech, or tactile input.

In addition, any priority document(s) of this application is/are hereby incorporated herein by reference in its/their entirety.

1. A monitoring system comprising:
a passive infrared, PIR, detector configured for detecting motion in an environment;
an active reflected wave detector arranged to measure wave reflections from a region of interest in the environment; wherein
the active reflected wave detector is operable responsive to detection of motion by the PIR detector; and
the system is configured to adjust at least one parameter of the PIR detector responsive to the output of the active reflected wave detector meeting one or more criteria, wherein
the one or more criteria are dependent on, or indicative of, a location of an entity represented in the output of the active reflected wave detector attributed to have caused the motion detected by the PIR detector, the attributed location being a location of an entity, determined from the output active reflected wave detector, when the output active reflected wave detector is operated in response to the motion detected by the PIR detector.

2. The monitoring system of claim 1, wherein the at least one parameter of the PIR detector defines a controllable behavioural characteristic of the PIR detector that determines how the PIR detector responds to a moving infrared-light emitting object and affects the operation of the PIR detector in determining motion.

3. The monitoring system of claim 1, wherein the at least one parameter of the PIR detector determines, sets or defines a sensing range of the PIR detector, the sensing range being a maximum distance the PIR detector can detect motion to at least a predetermined or set level.

4. The monitoring system of claim 1, wherein the at least one parameter comprises at least of the group selected from:
one or more detection thresholds used to determine whether a signal of the PIR detector is indicative of motion;
at least one parameter that defines one or more frequency bands of radiation that the PIR detector detects or is sensitive to:
a gain of the PIR detector;
a sensitivity of the PIR detector; and/or
at least one parameter of a transfer function or gain vs frequency profile of the PIR detector.

5. (canceled)

6. The monitoring system according to claim 1, wherein the one or more criteria are dependent on or indicative of a distance to an entity represented in the output of the active reflected wave detector.

7. The monitoring system of claim 1, wherein the system is configured to implement a virtual fence that defines at least part of the region of interest.

8. The monitoring system of claim 1, configured to calculate a maximum distance corresponding to the region of interest, the maximum distance being a distance from the PIR detector to a furthermost location of the region of interest therefrom, and further configured to set a default value of the at least one parameter of the PIR detector so that a default range of the PIR detector is based on said maximum distance.

9. The monitoring system of claim 1, configured to adjust the sensing range of the PIR detector by an amount dependent on the location of the entity represented in the output of the active reflected wave detector attributed to have caused the motion detected by the PIR detector.

10. The monitoring system of claim 7, configured to increase the sensing range of the PIR detector if the output of the active reflected wave detector indicates that an entity that is detected by the PIR detector to trigger the active reflected wave detector is within the virtual fence or within the virtual fence by at least a threshold distance when the active reflected wave detector is triggered.

11. The monitoring system of claim 7, configured to implement an outer virtual fence that is located beyond the virtual fence, wherein an outer region of interest spans between virtual fence and the outer virtual fence and wherein the system is configured to identify or distinguish between different scenarios relating to the position of an entity that is detected based on the active reflected wave detector upon being triggered by the PIR detector, the different scenarios comprising at least two or each of: the entity being outwith both the region of interest and beyond the outer region of interest; the entity being within the outer region of interest; and the entity is within the region of interest.

12. The monitoring system of claim 11, configured to:
increase the sensing range of the PIR detector when it is determined that the entity that is detected by the PIR detector to trigger the active reflected wave detector is within the region bound by the virtual fence when the active reflected wave detector is triggered; and/or
decrease the sensing range of the PIR detector when it is determined that the entity that is detected by the PIR detector to trigger the active reflected wave detector is outwith the region of interest and the outer region of interest when the active reflected wave detector is triggered; and/or
maintain the sensing range of the PIR detector unchanged if the entity that is detected by the PIR detector to trigger the active reflected wave detector is within the outer region of interest.

13. The monitoring system of claim 3, configured to increase the sensing range of the PIR detector to a default setting when it is determined that an entity that is detected by the PIR detector to trigger the active reflected wave detector is inside the region of interest when the active reflected wave detector is triggered.

14. The monitoring system of claim 1, configured to identify if an entity represented in the output of the active reflected wave detector attributed to have caused the motion detected by the PIR detector is a human and to only adjust the at least one parameter of the PIR detector responsive to the output of the active reflected wave detector meeting one or more criteria if the entity is a human.

15. (canceled)

16. The monitoring system of claim 1, configured to automatically at least partially reverse or reset the at least one parameter of the PIR detector with time.

17. (canceled)

18. The monitoring system of claim 1, configured to implement one or more counters for counting events or entities detected by the PIR detector and/or the active reflected wave detector, wherein the system is configured to adjust the at least one parameter of the PIR detector responsive to the output of the active reflected wave detector meeting one or more criteria only when the counter reaches a predefined number greater than 1.

19. The monitoring system of claim 1, wherein the one or more criteria comprise an analysis of an output of the active reflected wave detector or output derived therefrom determining that the detected motion by the PIR detector was caused by a non-human entity.

20. The monitoring system of claim 19, wherein the adjusting of the one or more parameters of the PIR detector responsive to the output of the active reflected wave detector meeting one or more criteria comprises adjusting one or more parameters of the PIR detector that determine the ability or sensitivity of the PIR detector to detect and/or identify non-human entities.

21. (canceled)

22. (canceled)

23. A method of operating a monitoring system, the monitoring system comprising: a passive infrared, PIR, detector configured for detecting motion in an environment; and an active reflected wave detector arranged to measure wave reflections from a region of interest in the environment; wherein the method comprises:
triggering or otherwise operating the active reflected wave detector responsive to detection of motion by the PIR detector; and
adjusting at least one parameter of the PIR detector responsive to the output of the active reflected wave detector meeting one or more criteria, wherein
the one or more criteria are dependent on, or indicative of, a location of an entity represented in the output of the active reflected wave detector attributed to have caused the motion detected by the PIR detector, the attributed location being a location of an entity, determined from the output active reflected wave detector, when the output active reflected wave detector is operated in response to the motion detected by the PIR detector.

24. A controller for a monitoring system that comprises a passive infrared, PIR, detector configured for detecting motion in an environment; and an active reflected wave detector arranged to measure wave reflections from a region of interest in the environment; wherein the controller is configured to:
receive signals output from the passive infrared, PIR, detector;
receive signals from the active reflected wave detector;
operate or trigger the active reflected wave detector responsive to detection of motion by the PIR detector; and
adjust at least one parameter of the PIR detector responsive to the output of the active reflected wave detector meeting one or more criteria, wherein
the one or more criteria are dependent on, or indicative of, a location of an entity represented in the output of the active reflected wave detector attributed to have caused the motion detected by the PIR detector, the attributed location being a location of an entity, determined from the output active reflected wave detector, when the output active reflected wave detector is operated in response to the motion detected by the PIR detector.

25. A tangible, non-transient computer readable medium comprising a computer program product configured such that, when implemented on a processing system or controller for a monitoring system, causes the processing system or controller to:
receive signals output from a passive infrared, PIR, detector configured for detecting motion in an environment;
receive signals from an active reflected wave detector arranged to measure wave reflections from a region of interest in the environment;
operate or trigger the active reflected wave detector responsive to detection of motion by the PIR detector; and
adjust at least one parameter of the PIR detector responsive to the output of the active reflected wave detector meeting one or more criteria, wherein
the one or more criteria are dependent on, or indicative of, a location of an entity represented in the output of the active reflected wave detector attributed to have caused the motion detected by the PIR detector, the attributed location being a location of an entity, determined from the output active reflected wave detector, when the output active reflected wave detector is operated in response to the motion detected by the PIR detector.
